(19) United States
(12) Patent Application Publication
(10) Pub. No.: US 2023/0371602 A1
(43) Pub. Date: Nov. 23, 2023

(54) INHALATION DEVICE, BASE MATERIAL, CONTROL METHOD, AND NON-TRANSITORY COMPUTER READABLE MEDIUM

(71) Applicant: JAPAN TOBACCO INC., Tokyo (JP)

(72) Inventors: Yasuhiro ONO, Tokyo (JP); Kazutoshi SERITA, Tokyo (JP); Reijiro KAWASAKI, Tokyo (JP); Hiroshi TEZUKA, Tokyo (JP)

(73) Assignee: JAPAN TOBACCO INC., Tokyo (JP)

(21) Appl. No.: 18/230,433

(22) Filed: Aug. 4, 2023

Related U.S. Application Data
(63) Continuation of application No. PCT/JP2021/015905, filed on Apr. 19, 2021.

(51) Int. Cl. A24F 40/465; A24F 40/57; A24F 40/53; A24F 40/20

(52) U.S. Cl. CPC A24F 40/465; A24F 40/57; A24F 40/53; A24F 40/20; A24F 40/51

(57) ABSTRACT

An inhalation device provided with: an AC power generation unit that generates AC power; an accommodation unit capable of accommodating in an inner space thereof a base material containing an aerosol source and a susceptor thermally proximal to the aerosol source; a plurality of electromagnetic induction sources that generate a variable magnetic field in the inner space by using the AC power supplied from the AC power generation unit; a plurality of switches that toggle between whether or not the AC power is supplied to each of the plurality of electromagnetic induction sources; and a control unit that controls each of the plurality of switches such that a total value of voltages respectively applied to the plurality of electromagnetic induction sources is no greater than a first threshold value.

### CROSS REFERENCES TO RELATED APPLICATIONS

This application is a continuation application based on International Patent Application No. PCT/JP2021/015905 filed on Apr. 19, 2021, and the content of the PCT international application is incorporated herein by reference.

### TECHNICAL FIELD

The present invention relates to an inhaler device, a substrate, a control method, and a non-transitory computer readable medium.

### BACKGROUND ART

An inhaler device that generates material to be inhaled by a user, such as an electronic tobacco and a nebulizer, is widely used. For example, an inhaler device uses a substrate including an aerosol source for producing an aerosol, a flavor source for imparting a flavor component to the generated aerosol, and the like, to generate an aerosol with the imparted flavor component. The user is able to taste a flavor by inhaling the aerosol with the imparted flavor component, generated by the inhaler device. An action that the user takes to inhale an aerosol is also referred to as puff or puff action below.

An inhaler device of a type using an external heat source, such as a heating blade, has been the mainstream so far. However, in recent years, an induction heating-type inhaler device that generates an aerosol by inductively heating a susceptor with an electromagnetic induction source configured as a coil has become a focus of attention. For example, the following PTL 1 describes a technology to control the temperature of a susceptor by controlling the time interval of a power pulse supplied to a coil in an induction heating-type inhaler device.

### CITATION LIST

Patent Literature 1: JP 2020-525014 A

### SUMMARY OF INVENTION

### Technical Problem

However, the technology described in PTL 1 just controls feeding of electric power to the coil in a time direction. Therefore, there is room for improvement in the quality of puff experience of a user.

The present invention is contemplated in view of the above problem, and it is an object of the present invention to provide a mechanism capable of further improving the quality of puff experience of a user.

### Solution to Problem

To solve the above problem, an aspect of the present invention provides an inhaler device. The inhaler device includes an alternating-current power generator that generates alternating-current power, a container capable of accommodating a substrate containing an aerosol source and a susceptor in thermal proximity to the aerosol source in an internal space, a plurality of electromagnetic induction sources that generate a varying magnetic field in the internal space by using the alternating-current power supplied from the alternating-current power generator, a plurality of switches that each switch whether to supply alternating-current power to a corresponding one of the plurality of electromagnetic induction sources, and a controller that controls each of the plurality of switches such that a total value of voltages respectively applied to the plurality of electromagnetic induction sources is lower than or equal to a first threshold.

Each of the switches may operate in a state of any one of a plurality of operating states, the plurality of operating states may include an on state where the alternating-current power is supplied to the electromagnetic induction source at a prescribed voltage and an off state where the alternating-current power is not supplied to the electromagnetic induction source, and, in a period during which any one of the plurality of switches is in the on state, the controller may set all the remainder of the switches to the off state.

The controller may provide a period during which all of the plurality of switches are set to the off state.

The plurality of operating states may include an attenuation state where the voltage of the alternating-current power supplied to the electromagnetic induction source gradually attenuates, and, in a period during which any one of the plurality of switches is in the on state or in the attenuation state, the controller may set all the remainder of the switches to the off state.

The plurality of operating states may include an attenuation state where the voltage of the alternating-current power supplied to the electromagnetic induction source gradually attenuates, and, in a period during which any one of the plurality of switches is in the attenuation state, the controller may set another one of the switches to the on state at timing at which the voltage of the alternating-current power supplied to the electromagnetic induction source corresponding to the switch in the attenuation state becomes lower than or equal to a second threshold.

Each of the switches may be a field effect transistor (FET), the on state may be a state where the voltage is applied to a gate electrode of the switch, the off state may be a state where no voltage is applied to the gate electrode of the switch and no current is flowing between a source electrode and a drain electrode, and the attenuation state may be a state where no voltage is applied to the gate electrode of the switch and a current is flowing between the source electrode and the drain electrode.

The container may have an opening that communicates the internal space with an outside and accommodates the substrate inserted into the internal space through the opening, and the plurality of electromagnetic induction sources may be disposed at different locations in a direction in which the substrate is inserted.

The controller may control each of the plurality of switches such that the switch operates in any one of a high heating mode in which a proportion of time during which the switch operates in the on state is high in a unit time, a low heating mode in which a proportion of time during which the switch operates in the on state is low in the unit time, and a non-heating mode in which the entire unit time is occupied by time during which the switch operates in the off state.

Of the plurality of electromagnetic induction sources, the controller may switch the switch that operates in the high heating mode with a lapse of time.

The controller may switch the switch that operates in the high heating mode in order from the switch corresponding to the electromagnetic induction source disposed closest to the opening to the switch corresponding to the electromagnetic induction source disposed farthest from the opening.

The controller may cause the switch to operate in the low heating mode after the switch operates in the high heating mode.

A temperature of the susceptor inductively heated by the electromagnetic induction source corresponding to the switch that operates in the low heating mode after the switch operates in the high heating mode may be a temperature higher than or equal to a temperature at which the aerosol does not condense.

When the controller switches the switch that operates in the high heating mode from a first switch to a second switch, the controller may cause the first switch to start operation in the low heating mode and, after a lapse of a predetermined time, cause the second switch to start operation in the high heating mode.

In the predetermined time, a temperature of the susceptor inductively heated by a first electromagnetic induction source corresponding to the first switch may decrease.

The predetermined time may be set such that, while an aerosol is being generated by induction heating performed by a first electromagnetic induction source corresponding to the first switch, an aerosol is generated by induction heating performed by a second electromagnetic induction source corresponding to the second switch.

Before the controller switches the switch that operates in the high heating mode from a first switch to a second switch, the controller may cause the second switch to operate in the non-heating mode.

Before the controller switches the switch that operates in the high heating mode from a first switch to a second switch, the controller may cause the second switch to operate in the low heating mode.

Also, to solve the above problem, another aspect of the present invention provides a substrate used with an inhaler device. The inhaler device includes an alternating-current power generator that generates alternating-current power, a container capable of accommodating a substrate containing an aerosol source and a susceptor in thermal proximity to the aerosol source in an internal space, a plurality of electromagnetic induction sources that generate a varying magnetic field in the internal space by using the alternating-current power supplied from the alternating-current power generator, a plurality of switches that each switch whether to supply alternating-current power to a corresponding one of the plurality of electromagnetic induction sources, and a controller that controls each of the plurality of switches such that a total value of voltages respectively applied to the plurality of electromagnetic induction sources is lower than or equal to a first threshold. The substrate is accommodated in the container. The substrate includes the aerosol source, and the susceptor in thermal proximity to the aerosol source.

Also, to solve the above problem, another aspect of the present invention provides a control method for controlling an inhaler device. The inhaler device includes an alternating-current power generator that generates alternating-current power, a container capable of accommodating a substrate containing an aerosol source and a susceptor in thermal proximity to the aerosol source in an internal space, a plurality of electromagnetic induction sources that generate a varying magnetic field in the internal space by using the alternating-current power supplied from the alternating-current power generator, and a plurality of switches that each switch whether to supply alternating-current power to a corresponding one of the plurality of electromagnetic induction sources. The control method includes controlling each of the plurality of switches such that a total value of voltages respectively applied to the plurality of electromagnetic induction sources is lower than or equal to a first threshold.

Also, to solve the above problem, another aspect of the present invention provides a program to be executed by a computer that controls an inhaler device. The inhaler device includes an alternating-current power generator that generates alternating-current power, a container capable of accommodating a substrate containing an aerosol source and a susceptor in thermal proximity to the aerosol source in an internal space, a plurality of electromagnetic induction sources that generate a varying magnetic field in the internal space by using the alternating-current power supplied from the alternating-current power generator, and a plurality of switches that each switch whether to supply alternating-current power to a corresponding one of the plurality of electromagnetic induction sources. The program executes controlling each of the plurality of switches such that a total value of voltages respectively applied to the plurality of electromagnetic induction sources is lower than or equal to a first threshold.

### Advantageous Effects of Invention

As described above, according to the present invention, a mechanism capable of further improving the quality of puff experience of a user is provided.

### BRIEF DESCRIPTION OF DRAWINGS

FIG. 1 is a schematic diagram that schematically illustrates a configuration example of an inhaler device.

FIG. 2 is a block diagram that illustrates a configuration related to induction heating performed by the inhaler device 100 according to a present embodiment.

FIG. 3 is an equivalent circuit of a circuit related to induction heating performed by the inhaler device 100 according to the present embodiment.

FIG. 4 is a timing chart for illustrating the operation modes of a switch 164 according to the present embodiment.

FIG. 5 is a graph that shows an example of time-series changes of a real temperature of a susceptor 161 inductively heated in accordance with a heating profile shown in Table 1.

FIG. 6 is a timing chart for illustrating an example of the operations of a switch 164A and a switch 164B in a first temperature increasing interval.

FIG. 7 is a timing chart for illustrating an example of the operations of the switch 164A and the switch 164B in an in-process temperature decreasing interval.

FIG. 8 is a timing chart for illustrating an example of the operations of the switch 164A and the switch 164B in a second temperature increasing interval.

FIG. 9 is a flowchart that illustrates an example of the flow of a process that is executed by the inhaler device 100 according to the present embodiment.

FIG. 10 is a timing chart for illustrating another example of the operations of the switch 164A and the switch 164B in the second temperature increasing interval.

FIG. 11 is a graph that shows an example of time-series changes of a real temperature of the susceptor 161 inductively heated in accordance with a heating profile shown in Table 2.

FIG. 12 is a timing chart for illustrating an example of the operations of the switch 164A and the switch 164B in the first temperature increasing interval.

FIG. 13 is a timing chart for illustrating an example of the operations of the switch 164A and the switch 164B in the in-process temperature decreasing interval.

### DESCRIPTION OF EMBODIMENTS

Hereinafter, a preferred embodiment of the present invention will be described in detail with reference to the attached drawings. In the specification and the drawings, like reference signs denote structural elements having substantially the same functional components, and the description will not be repeated.

### 1. Configuration Example of Inhaler Device

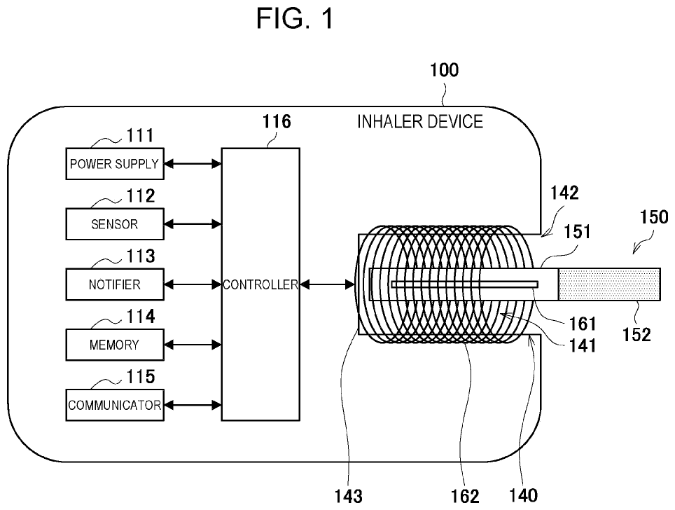

An inhaler device according to the present configuration example generates an aerosol by heating a substrate containing an aerosol source by means of induction heating (IH). Hereinafter, the present configuration example will be described with reference to FIG. 1.

FIG. 1 is a schematic diagram that schematically illustrates a configuration example of an inhaler device. As illustrated in FIG. 1, an inhaler device 100 according to the present configuration example includes a power supply 111, a sensor 112, a notifier 113, a memory 114, a communicator 115, a controller 116, an electromagnetic induction source 162, and a holder 140. A user inhales in a state where a stick substrate 150 is held by the holder 140. Hereinafter, structural elements will be sequentially described.

The power supply 111 stores electric power. The power supply 111 supplies electric power to the structural elements of the inhaler device 100. The power supply 111 can be a rechargeable battery, such as a lithium ion secondary battery. The power supply 111 may be charged when connected to an external power supply with a universal serial bus (USB) cable or the like. Alternatively, the power supply 111 may be charged with a wireless power transmission technology in a state not connected to a power transmitting device. Other than the above, only the power supply 111 may be allowed to be removed from the inhaler device 100 or may be allowed to be replaced with a new power supply 111.

The sensor 112 detects various items of information regarding the inhaler device 100. The sensor 112 outputs the detected information to the controller 116. In an example, the sensor 112 is a pressure sensor, such as a capacitor microphone, a flow sensor, or a temperature sensor. When the sensor 112 detects a numeric value resulting from user's inhalation, the sensor 112 outputs, to the controller 116, information indicating that the user has inhaled In another example, the sensor 112 is an input device that receives information input by the user, such as a button and a switch. Particularly, the sensor 112 can include a button for instructions to start or stop generating an aerosol. The sensor 112 outputs, to the controller 116, information input by the user. In another example, the sensor 112 is a temperature sensor that detects the temperature of the susceptor 161. The temperature sensor, for example, detects the temperature of the susceptor 161 in accordance with an electric resistance value of the electromagnetic induction source 162. The sensor 112 may detect the temperature of the stick substrate 150 held by the holder 140 in accordance with the temperature of the susceptors 161.

The notifier 113 notifies the user of information. In an example, the notifier 113 is a light-emitting device, such as a light emitting diode (LED). In this case, the notifier 113 emits light in a different pattern of light, for example, when the state of the power supply 111 is a charging required state, when the power supply 111 is in being charged, or when there is an abnormality in the inhaler device 100. The pattern of light here is a concept including color, the timing to turn on or off, and the like. The notifier 113 may be a display device that displays an image, a sound output device that outputs sound, or a vibration device that vibrates, in addition to or instead of the light-emitting device. Other than the above, the notifier 113 may notify information indicating that the user is allowed to inhale. The information indicating that the user is allowed to inhale is notified when the temperature of the stick substrate 150 heated by electromagnetic induction reaches a predetermined temperature.

The memory 114 stores various items of information for the operation of the inhaler device 100. The memory 114 is, for example, a non-volatile storage medium, such as a flash memory. An example of the pieces of information stored in the memory 114 is information regarding an operating system (OS) of the inhaler device 100, such as the content of control over various structural elements by the controller 116. Another example of the items of information stored in the memory 114 is information regarding user's inhalation, such as the number of times of inhalation, inhalation time, and an accumulated inhalation time period.

The communicator 115 is a communication interface for transmitting and receiving information between the inhaler device 100 and another device. The communicator 115 performs communication that conforms with any wired or wireless communication standard. A wireless local area network (LAN), a wired LAN, Wi-Fi (registered trademark), Bluetooth (registered trademark), or the like can be adopted as such a communication standard. In an example, the communicator 115 transmits information regarding user's inhalation to a smartphone in order to display the information regarding user's inhalation on the smartphone. In another example, the communicator 115 receives new information on the OS from a server in order to update the information on the OS, stored in the memory 114.

The controller 116 functions as an arithmetic processing unit and a control unit and controls the overall operations in the inhaler device 100 in accordance with various programs. The controller 116 includes an electronic circuit, such as a central processing unit (CPU) and a microprocessor. The controller 116 may further include a read only memory (ROM) that stores programs and arithmetic parameters to be used, and a random access memory (RAM) that temporarily stores variable parameters as needed. The inhaler device 100 executes various pieces of processing in accordance with control by the controller 116. Feeding of electric power from the power supply 111 to another structural element, charging of the power supply 111, detection of information by the sensor 112, notification of information by the notifier 113, storing and reading of information by the memory 114, and transmitting and receiving of information by the communicator 115 each are an example of the pieces of processing to be controlled by the controller 116. Other pieces of processing to be executed by the inhaler device 100, such as input of information to each structural element and processing based on information output from each structural element, are controlled by the controller 116.

The holder 140 has an internal space 141. The holder 140 holds the stick substrate 150 while accommodating part of the stick substrate 150 in the internal space 141. The holder 140 has an opening 142 that allows the internal space 141 to communicate with outside. The holder 140 holds the stick substrate 150 that is inserted into the internal space 141 through the opening 142. For example, the holder 140 is a tubular body having the opening 142 and a bottom 143 at the ends, and defines the columnar internal space 141. The holder 140 can be formed such that the inside diameter is smaller than the outside diameter of the stick substrate 150 in at least part of the tubular body in the height direction of the tubular body. The holder 140 can hold the stick substrate 150 such that the stick substrate 150 inserted in the internal space 141 is pressed from the outer circumference. The holder 140 also has the function to define a flow path for air passing through the stick substrate 150. An air inlet hole that is an inlet for air into the flow path is disposed at, for example, the bottom 143. On the other hand, an air outlet hole that is an outlet for air from the flow path is the opening 142.

The stick substrate 150 is a stick member. The stick substrate 150 includes a substrate 151 and an inhalation port 152.

The substrate 151 includes an aerosol source. When the aerosol source is heated, the aerosol source is atomized to generate an aerosol. The aerosol source may be, for example, a substance derived from tobacco, such as a processed substance obtained by forming shredded tobacco or tobacco raw material into a granular form, a sheet form, or a powder form. The aerosol source may contain a substance not derived from tobacco and made from a plant other than tobacco (for example, mint, a herb, or the like). In an example, the aerosol source may contain a flavor component, such as menthol. When the inhaler device 100 is a medical inhaler, the aerosol source may contain a medicine for a patient to inhale. The aerosol source is not limited to a solid and may be, for example, a liquid, such as polyhydric alcohol and water. Examples of the polyhydric alcohol include glycerine and propylene glycol. At least part of the substrate 151 is accommodated in the internal space 141 of the holder 140 in a state where the stick substrate 150 is held by the holder 140.

The inhalation port 152 is a member to be held in a mouth of the user during inhalation. At least part of the inhalation port 152 protrudes from the opening 142 in a state where the stick substrate 150 is held by the holder 140. When the user inhales with the inhalation port 152 protruding from the opening 142 in his or her mouth, air flows into the holder 140 through the air inlet hole (not illustrated). Air flowing in passes through the internal space 141 of the holder 140, that is, passes through the substrate 151, and reaches the inside of the mouth of the user together with an aerosol that is generated from the substrate 151.

The stick substrate 150 further includes the susceptor 161. The susceptor 161 produces heat by electromagnetic induction. The susceptor 161 is made of a conductive raw material, such as a metal. In an example, the susceptor 161 is formed in a sheet shape. The susceptor 161 is disposed such that the longitudinal direction of the susceptor 161 coincides with the longitudinal direction of the stick substrate 150.

Here, the susceptor 161 is disposed in thermal proximity to the aerosol source. The state where the susceptor 161 is in thermal proximity to the aerosol source means that the susceptor 161 is disposed at a position where heat generated at the susceptor 161 is transferred to the aerosol source. For example, the susceptor 161 is included in the substrate 151 together with the aerosol source and surrounded by the aerosol source. With this configuration, heat generated from the susceptor 161 can be efficiently used to heat the aerosol source.

The susceptor 161 may be untouchable from outside of the stick substrate 150. For example, the susceptor 161 may be distributed in a central part of the stick substrate 150 but does not need to be distributed near the outer circumference of the stick substrate 150.

The electromagnetic induction source 162 causes the susceptor 161 to produce heat by electromagnetic induction. The electromagnetic induction source 162 is, for example, a coiled conductive wire wound around the outer circumference of the holder 140. When the electromagnetic induction source 162 is supplied with alternating current from the power supply 111, the electromagnetic induction source 162 generates a magnetic field. The electromagnetic induction source 162 is disposed at a position where the internal space 141 of the holder 140 overlaps the generated magnetic field. Thus, when the magnetic field is generated in a state where the stick substrate 150 is held by the holder 140, eddy current is generated in the susceptor 161, and Joule heat is generated. Subsequently, the aerosol source included in the stick substrate 150 is heated and atomized by the Joule heat to generate an aerosol. In an example, when the sensor 112 detects that predetermined user input is performed, electric power may be fed to generate an aerosol. When the temperature of the stick substrate 150 inductively heated by the susceptor 161 and the electromagnetic induction source 162 reaches a predetermined temperature, the user is allowed to inhale. After that, when the sensor 112 detects that the predetermined user input is performed, feeding of electric power may be stopped. In another example, in a period during which the sensor 112 detects that the user has inhaled, electric power may be fed to generate an aerosol.

FIG. 1 shows an example in which the susceptor 161 is included in the substrate 151 of the stick substrate 150; however, the present configuration example is not limited to this example. For example, the holder 140 may have the function of the susceptor 161. In this case, eddy current is generated in the holder 140 by the magnetic field generated by the electromagnetic induction source 162, and Joule heat is generated. Subsequently, the aerosol source included in the stick substrate 150 is heated and atomized by the Joule heat to generate an aerosol.

In terms of the point that an aerosol can be generated by combining the inhaler device 100 with the stick substrate 150, a combination of the inhaler device 100 with the stick substrate 150 may be regarded as one system.

<2. Induction Heating>

Induction heating will be described in detail below.

Induction heating is a process of causing a varying magnetic field to enter a conductive physical object to heat the physical object. A magnetic field generator that generates a varying magnetic field and a conductive heated object that is heated when exposed to a varying magnetic field relate to induction heating. An example of the varying magnetic field is an alternating magnetic field. The electromagnetic induction source 162 illustrated in FIG. 1 is an example of the magnetic field generator. The susceptor 161 illustrated in FIG. 1 is an example of the heated object.

When a varying magnetic field is generated from the magnetic field generator in a state where the magnetic field generator and the heated object are disposed in a relative position such that the varying magnetic field generated from the magnetic field generator enters the heated object, eddy current is induced in the heated object. When the eddy current flows through the heated object, Joule heat according to the electrical resistance of the heated object is generated to heat the heated object. Such heating is also referred to as Joule heating, ohmic heating, or resistance heating.

The heated object may have magnetism. In this case, the heated object is further heated by magnetic hysteresis heating. Magnetic hysteresis heating is a process of causing a varying magnetic field to enter a magnetic object to heat the object. When a magnetic field enters a magnetic substance, magnetic dipoles contained in the magnetic substance are aligned along the magnetic field. Therefore, when a varying magnetic field enters a magnetic substance, the orientations of the magnetic dipoles change with the varying magnetic field applied. With such reorientation of the magnetic dipoles, heat is generated in the magnetic substance, and the heated object is heated.

Magnetic hysteresis heating typically occurs at a temperature lower than or equal to a Curie point and does not occur at a temperature exceeding the Curie point. A Curie point is a temperature at which a magnetic substance loses its magnetic properties. For example, when the temperature of a heated object having a ferromagnetism at a temperature lower than or equal to a Curie point exceeds the Curie point, a reversible phase transition from ferromagnetism to paramagnetism occurs in the magnetism of the heated object. When the temperature of the heated object exceeds the Curie point, magnetic hysteresis heating does not occur any more, so the rate of increase in temperature reduces.

The heated object is desirably made of a conductive material. The heated object is further desirably made of a material having ferromagnetism. This is because, in the latter case, heating efficiency can be increased by a combination of resistance heating and magnetic hysteresis heating. For example, the heated object is made of one or more raw materials selected from a raw material group consisting of aluminum, iron, nickel, cobalt, conductive carbon, copper, stainless steel, and the like.

In both resistance heating and magnetic hysteresis heating, heat is not generated by heat conduction from an external heat source but generated in the heated object. Therefore, a steep increase in temperature and a uniform heat distribution in the heated object can be implemented. This can be implemented by appropriately designing the material and shape of the heated object and the magnitude and orientation of the varying magnetic field. In other words, a steep increase in temperature and a uniform heat distribution in the stick substrate 150 can be implemented by appropriately designing the distribution of the susceptor 161 included in the stick substrate 150. Therefore, it is possible to shorten time for preheating, and it is also possible to improve the quality of a flavor tasted by the user.

Since induction heating directly heats the susceptor 161 included in the stick substrate 150, it is possible to efficiently heat the substrate as compared to when the stick substrate 150 is heated from the outer circumference or the like with an external heat source. When heating using an external heat source is performed, the external heat source inevitably becomes a higher temperature than the stick substrate 150. On the other hand, when induction heating is performed, the electromagnetic induction source 162 does not become a higher temperature than the stick substrate 150. Therefore, the temperature of the inhaler device 100 can be maintained at low temperatures as compared to when an external heat source is used, so it is a great benefit in relation to user's safety.

The electromagnetic induction source 162 generates a varying magnetic field by using electric power supplied from the power supply 111. In an example, the power supply 111 may be a direct current (DC) power supply. In this case, the power supply 111 supplies alternating-current power to the electromagnetic induction source 162 via a DC/AC (alternate current) inverter In this case, the electromagnetic induction source 162 can generate an alternating magnetic field.

The electromagnetic induction source 162 is disposed at a location where a varying magnetic field generated from the electromagnetic induction source 162 enters the susceptor 161 disposed in thermal proximity to the aerosol source contained in the stick substrate 150 held by the holder 140. The susceptor 161 produces heat when a varying magnetic field enters the susceptor 161. The electromagnetic induction source 162 illustrated in FIG. 1 is a solenoid coil. The solenoid coil is disposed such that a conductive wire winds around the outer circumference of the holder 140. When current is applied to the solenoid coil, a magnetic field is generated in a central space surrounded by the coil, that is, the internal space 141 of the holder 140. As illustrated in FIG. 1, in a state where the stick substrate 150 is held by the holder 140, the susceptor 161 is surrounded by the coil. Therefore, the varying magnetic field generated from the electromagnetic induction source 162 enters the susceptor 161 to inductively heat the susceptor 161.

<3. Technical Features>

(1) Detailed Internal Configuration

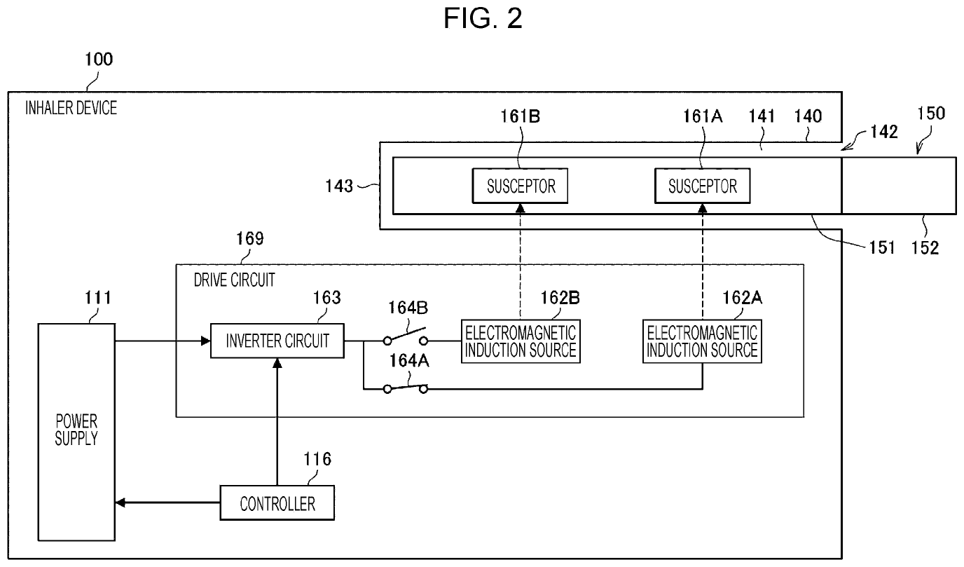

A configuration related to induction heating according to the present embodiment will be described in detail with reference to FIG. 2. FIG. 2 is a block diagram that illustrates a configuration related to induction heating performed by the inhaler device 100 according to the present embodiment.

As shown in FIG. 2, the inhaler device 100 includes a drive circuit 169 including the electromagnetic induction sources 162 (162A, 162B), an inverter circuit 163, and switches 164 (164A, 164B). The drive circuit 169 is a circuit for generating a varying magnetic field. The drive circuit 169 may further include another circuit, such as a matching circuit. The drive circuit 169 operates on electric power supplied from the power supply 111.

The power supply 111 is a direct current (DC) power supply. The power supply 111 supplies direct-current power.

The inverter circuit 163 is a DC-AC (alternating current) inverter that converts direct-current power to alternating-current power. In an example, the inverter circuit 163 is configured as a half-bridge inverter or a full-bridge inverter having one or more switching elements. Examples of the switching element include a metal-oxide-semiconductor field effect transistor (MOSFET) and an insulated gate bipolar transistor (IGBT). The power supply 111 and the inverter circuit 163 are an example of an alternating-current power generator that generates alternating-current power.

The holder 140 is an example of a container capable of accommodating, in an internal space, the stick substrate 150 that is a substrate containing an aerosol source and the susceptor 161 in thermal proximity to the aerosol source. As shown in FIG. 2, the stick substrate 150 may have a plurality of the susceptors 161 (161A, 161B). Each of the susceptor 161A and the susceptor 161B is formed in, for example, a sheet shape and is disposed at a different location in the longitudinal direction of the stick substrate 150.

In the holder 140 and the internal space 141, a side close to the bottom 143 is also referred to as upstream side, and a side close to the opening 142 is also referred to as downstream side. This is because airflow is generated from the upstream side toward the downstream side at the time when a puff is taken.

As shown in FIG. 2, the inhaler device 100 includes the plurality of electromagnetic induction sources 162 (162A, 162B). Each of the plurality of electromagnetic induction sources 162 generates a varying magnetic field in the internal space 141 by using alternating-current power supplied from the inverter circuit 163. Here, each of the plurality of electromagnetic induction sources 162 is disposed at a different location in a direction in which the stick substrate 150 is inserted. The direction in which the stick substrate 150 is inserted is a direction from the opening 142 toward the bottom 143 and is typically the longitudinal direction of the internal space 141. Each of the plurality of electromagnetic induction sources 162 is disposed at a location corresponding to a corresponding one of the plurality of susceptors 161 in a state where the stick substrate 150 is held by (that is, accommodated in) the holder 140. Specifically, in a state where the stick substrate 150 is held by the holder 140, the susceptor 161A is surrounded by the electromagnetic induction source 162A, and the susceptor 161B is surrounded by the electromagnetic induction source 162B. Therefore, the electromagnetic induction source 162A is capable of inductively heating the susceptor 161A, and the electromagnetic induction source 162B is capable of inductively heating the susceptor 161B.

As shown in FIG. 2, the inhaler device 100 includes the plurality of switches 164 (164A, 164B), each of which switches whether to supply alternating-current power to a corresponding one of the plurality of electromagnetic induction sources 162. The switch 164A is disposed between the inverter circuit 163 and the electromagnetic induction source 162A. The switch 164A electrically connects the electromagnetic induction source 162A with the inverter circuit 163 or electrically disconnects the electromagnetic induction source 162A from the inverter circuit 163. The switch 164B is disposed between the inverter circuit 163 and the electromagnetic induction source 162B. The switch 164B electrically connects the electromagnetic induction source 162B with the inverter circuit 163 or electrically disconnects the electromagnetic induction source 162B from the inverter circuit 163. Thus, the inhaler device 100 is capable of selectively inductively heating at least any one of the susceptor 161A and the susceptor 161B.

The controller 116 controls induction heating performed by the electromagnetic induction source 162. Specifically, the controller 116 controls feeding of electric power to the electromagnetic induction source 162. For example, the controller 116 estimates the temperature of the susceptor 161 in accordance with information on direct-current power supplied from the power supply 111 to the drive circuit 169. The controller 116 controls feeding of electric power to the electromagnetic induction source 162 in accordance with the estimated temperature of the susceptor 161. For example, the controller 116 controls feeding of electric power to the electromagnetic induction source 162 such that the temperature of the susceptor 161 changes in accordance with a heating profile (described later).

An example of a controlled object is the voltage of direct-current power supplied from the power supply 111 to the drive circuit 169. Another example of the controlled object is a switching period in the inverter circuit 163. Another example of the controlled object is operation of each of the plurality of switches 164.

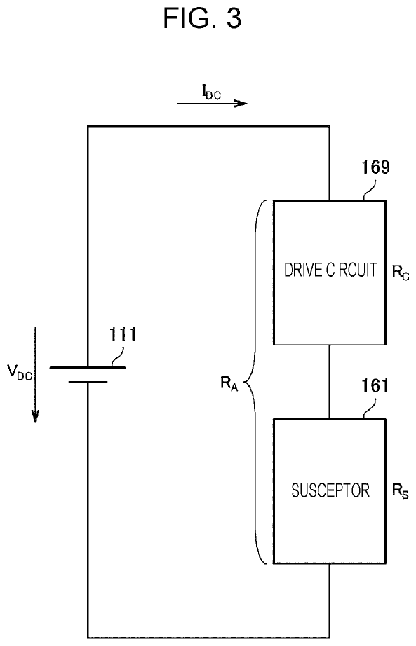

A method of estimating the temperature of the susceptor 161 will be simply described with reference to FIG. 3.

FIG. 3 is an equivalent circuit of a circuit related to induction heating performed by the inhaler device 100 according to the present embodiment. An apparent electric resistance value R_{A} illustrated in FIG. 3 is an electric resistance value of a closed circuit including the drive circuit 169, calculated by using a current value I_{DC} and a voltage value V_{DC} of direct-current power supplied from the power supply 111 to the drive circuit 169. As shown in FIG. 3, the apparent electric resistance value R_{A} corresponds to series connection of an electric resistance value Rc of the drive circuit 169 and an electric resistance value Rₛ of the susceptor 161. There is a very monotonous relationship between the apparent electric resistance value R_{A} and the temperature of the susceptor 161. For example, within a range (for example, 0° C. to 400° C. or the like) in which the susceptor 161 can change in temperature due to induction heating performed by the inhaler device 100, there can be a substantially linear relationship between the apparent electric resistance value R_{A} and the temperature of the susceptor 161. For this reason, the controller 116 is allowed to calculate the apparent electric resistance value R_{A} in accordance with a current value I_{DC} and a voltage value V_{DC} and estimate the temperature of the susceptor 161 in accordance with the apparent electric resistance value R_{A}.

(2) Control over Switches 164

The controller 116 controls the plurality of switches 164 to selectively supply alternating-current power to at least any one of the plurality of electromagnetic induction sources 162. Thus, it is possible to selectively inductively heat at least any one of the plurality of susceptors 161.

Each of the switches 164 may be a field effect transistor (FET). An FET is a transistor having a gate electrode, a source electrode, and a drain electrode. It is possible to control a current flowing between the source electrode and the drain electrode by controlling a voltage applied to the gate electrode. Typically, when a voltage is applied to the gate electrode, a current flows between the source electrode and the drain electrode. On the other hand, when no voltage is applied to the gate electrode, no current flows between the source electrode and the drain electrode.

Each of the switches 164 operates in a state of any one of a plurality of operating states. The plurality of operating states includes an on state and an off state. The on state is an operating state in which alternating-current power is supplied to the electromagnetic induction source 162 at a prescribed voltage. Specifically, the on state is a state where a voltage is applied to the gate electrode of the switch 164. The off state is an operating state in which no alternating-current power is supplied to the electromagnetic induction source 162. Specifically, the off state is a state in which no voltage is applied to the gate electrode of the switch 164 and no current is flowing between the source electrode and the drain electrode.

Here, switching from the off state to the on state is instantaneously performed when application of a voltage to the gate electrode is started. On the other hand, switching from the on state to the off state takes a considerable time from when application of a voltage to the gate electrode is stopped. This is because it takes time for electric charge to be depleted from the gate electrode.

In other words, the operating state of the switch 164 includes an attenuation state in which the voltage of alternating-current power supplied to the electromagnetic induction source 162 gradually attenuates. The attenuation state is a state where no voltage is applied to the gate electrode of the switch 164 and a current is flowing between the source electrode and the drain electrode. In other words, the attenuation state is a state during times from when application of a voltage to the gate electrode is stopped to when electric charge is completely depleted from the gate electrode.

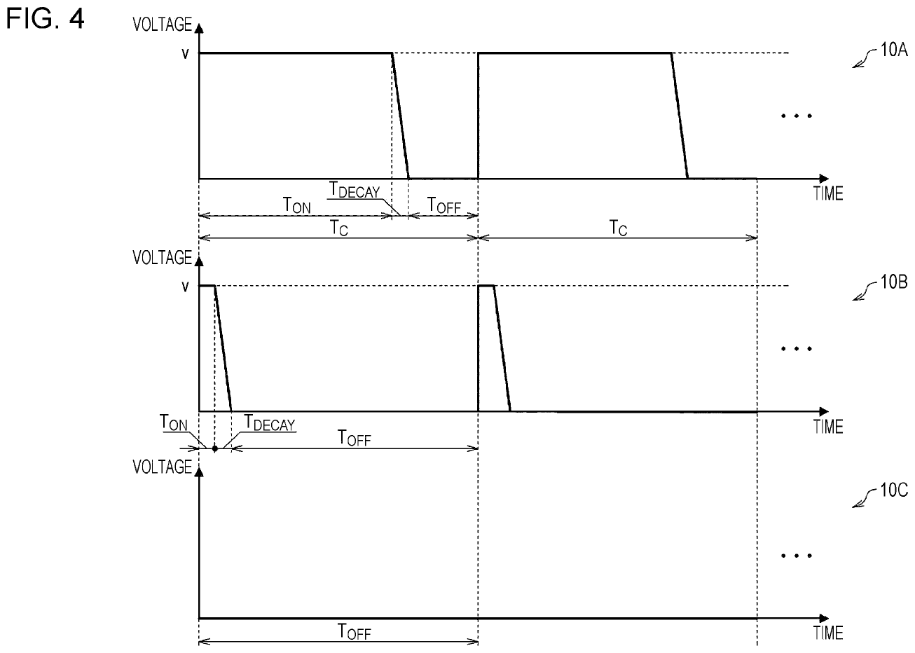

The controller 116 controls each of the plurality of switches 164 such that the switch 164 operates in any one operation mode of a high heating mode, a low heating mode, and a non-heating mode. The high heating mode is an operation mode in which the operating state of the switch 164 corresponding to the electromagnetic induction source 162 that inductively heats the susceptor 161 is controlled such that the susceptor 161 becomes a high temperature. The low heating mode is an operation mode in which the operating state of the switch 164 corresponding to the electromagnetic induction source 162 that inductively heats the susceptor 161 is controlled such that the susceptor 161 becomes a low temperature. The non-heating mode is an operation mode in which the operating state of the switch 164 corresponding to the electromagnetic induction source 162 that inductively heats the susceptor 161 is controlled such that the susceptor 161 is not heated. With the above configuration, it is possible to control the temperature of the susceptor 161 by controlling the operation mode of the switch 164. These operation modes will be described with reference to FIG. 4.

FIG. 4 is a timing chart for illustrating the operation modes of the switch 164 according to the present embodiment. A graph 10A shows time-series changes in voltage applied to the electromagnetic induction source 162 corresponding to (that is, connected to) the switch 164 that operates in the high heating mode. A graph 10B shows time-series changes in voltage applied to the electromagnetic induction source 162 corresponding to the switch 164 that operates in the low heating mode. A graph 10C shows time-series changes in voltage applied to the electromagnetic induction source 162 corresponding to the switch 164 that operates in the non-heating mode. The abscissa axes of these graphs represent time. The ordinate axes of these graphs represent an effective value of voltage of alternating-current power applied to the electromagnetic induction source 162.

T_{ON} denotes a time period during which the switch 164 operates in the on state. In the on state, a prescribed voltage v is applied to the electromagnetic induction source 162. T_{OFF} denotes a time period during which the switch 164 operates in the off state. T_{DECAY} denotes a time period during which the switch 164 operates in the attenuation state. The switch 164 repeats application of a voltage to the electromagnetic induction source 162, shown in the graphs 10A to 10C, with a unit time T_{C} as a period.

As shown in the graph 10A, the high heating mode is an operation mode in which the proportion of time T_{ON} during which the switch 164 operates in the on state in the unit time T_{C} is high. More specifically, the proportion of time T_{ON} in the unit time T_{C} in the high heating mode is higher than the proportion of time T_{ON} in the unit time T_{C} in the low heating mode. The proportion of time T_{ON} in the unit time T_{C} may be higher than the proportion of time T_{OFF} in the unit time T_{C}.

As shown in the graph 10B, the low heating mode is an operation mode in which the proportion of time T_{ON} during which the switch 164 operates in the on state in the unit time T_{C} is low. More specifically, the proportion of time T_{ON} in the unit time T_{C} in the low heating mode is higher than the proportion of time T_{ON} in the unit time T_{C} in the high heating mode. The proportion of time T_{ON} in the unit time T_{C} may be lower than the proportion of time T_{OFF} in the unit time T_{C}.

As shown in the graph 10C, the non-heating mode is an operation mode in which time T_{OFF} during which the switch 164 operates in the off state occupies the entire unit time T_{C}.

Referring to the waveforms at the commencement of time T_{ON}, at the time of switching from the off state to the on state, a voltage applied to the electromagnetic induction source 162 rises substantially vertically. On the other hand, referring to the waveforms in time T_{DECAY}, at the time of switching from the on state to the off state, a voltage applied to the electromagnetic induction source 162 decreases downward toward the right side.

(3) Control over Switch 164 According to Heating Profile

The inhaler device 100 controls feeding of electric power to the electromagnetic induction source 162 in accordance with a heating profile. The heating profile is information in which time-series changes of a target temperature that is a target value of the temperature of the susceptor 161 are defined. The inhaler device 100 controls feeding of electric power to the electromagnetic induction source 162 such that the actual temperature (hereinafter, also referred to as real temperature) of the susceptor 161 changes as in the case of time-series changes of the target temperature defined in the heating profile. Thus, an aerosol is generated as planned by the heating profile. The heating profile is typically designed such that a flavor tasted by a user is optimal when the user inhales an aerosol generated from the stick substrate 150. Thus, it is possible to optimize a flavor tasted by the user by controlling the operation of the electromagnetic induction source 162 in accordance with the heating profile.

The heating profile includes one or more combinations of an elapsed time from when heating is started with a target temperature to be reached with the elapsed time. The controller 116 controls the temperature of the susceptor 161 in accordance with a deviation between a current real temperature and a target temperature in the heating profile corresponding to an elapsed time from when current heating is started. Temperature control over the susceptor 161 can be implemented by, for example, known feedback control. In feedback control, the controller 116 may control electric power supplied to the electromagnetic induction source 162 in accordance with a difference between a real temperature and a target temperature, or other information. Feedback control may be, for example, proportional-integral-differential controller (PID control). Alternatively, the controller 116 may execute simple ON-OFF control. For example, the controller 116 may perform feeding of electric power to the electromagnetic induction source 162 until a real temperature reaches a target temperature and, when the real temperature reaches the target temperature, intermit feeding of electric power to the electromagnetic induction source 162.

A time interval from when a process of generating an aerosol by using the stick substrate 150 is started to when the process ends, more specifically, a time interval in which the electromagnetic induction source 162 operates in accordance with the heating profile, is also referred to as heating session below. Commencement of a heating session is timing at which heating based on the heating profile is started. Termination of a heating session is timing at which a sufficient amount of aerosol is not generated. A heating session consists of a first-half preliminary heating period and a second-half puff available period. A puff available period is a period during which a sufficient amount of aerosol is assumed to be generated. A preliminary heating period is a period from when heating is started to when a puff available period is started. Heating performed in a preliminary heating period is also referred to as preliminary heating.

The inhaler device 100 includes the plurality of electromagnetic induction sources 162. For this reason, the heating profile according to the present embodiment is information in which time-series changes of the target temperature that is a target value of the temperature of each of the plurality of susceptors 161 are defined. An example of the heating profile is shown in the following Table 1.

TABLE 1
Table 1 Example of Heating Profile

| | Elapsed Time from | Target Temperature | Target Temperature |
|---|---|---|---|
| Time Interval | Start of Heating | of Susceptor 161A | of Susceptor 161B |
| First Temperature | t₁ (s) | tmp₁° C. | — |
| Increasing Interval | t₂ (s) | tmp₁° C. | — |
| In-Process Temperature | t₃ (s) | tmp₂° C. | — |
| Decreasing Interval | | | |
| Second Temperature | t₄ (s) | tmp₂° C. | tmp₁° C. |
| Increasing Interval | t₅ (s) | tmp₂° C. | tmp₁° C. |
| Heating End Interval | Thereafter | — | — |

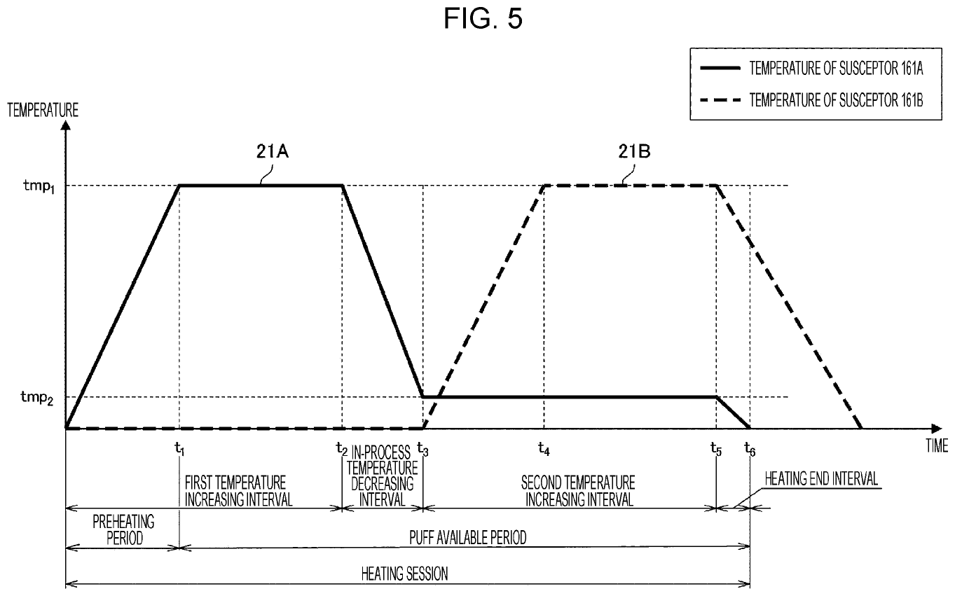

FIG. 5 is a graph that shows an example of time-series changes of a real temperature of the susceptor 161 inductively heated in accordance with a heating profile shown in Table 1. The abscissa axis of the graph represents time (s). The ordinate axis of the graph represents the temperature of the susceptor 161. The line 21A represents time-series changes of the real temperature of the susceptor 161A. The line 21B represents time-series changes of the real temperature of the susceptor 161B. As shown in FIG. 5, the real temperature of each of the susceptors 161A, 161B changes as in the case of time-series changes of the target temperature defined in the heating profile. In the example shown in FIG. 5, the period from the start of heating to t₁ seconds later is a preliminary heating period. A period from t₁ seconds after the start of heating to t₆ seconds after the start of heating is a puff available period.

As shown in Table 1 and FIG. 5, the temperature of the susceptor 161A is increased up to tmp₁° C. and maintained in a first temperature increasing interval, decreased up to tmp₂° C. in an in-process temperature decreasing interval, and maintained at tmp₂° C. in a second temperature increasing interval. On the other hand, the temperature of the susceptor 161B is maintained at an initial temperature in the first temperature increasing interval and the in-process temperature decreasing interval, and increased up to tmp₁° C. and maintained in the second temperature increasing interval. In the heating end interval, feeding of electric power to the electromagnetic induction source 162A and the electromagnetic induction source 162B is stopped, and the temperature of each decreases. An initial temperature is a temperature assumed as the temperature of the susceptor 161 before the start of heating.

The time length of each interval may be shortened according to the number of puffs taken in the interval. This is because, as the number of puffs increases, a rate at which an aerosol source is consumed increases. For example, each interval may terminate when the number of puffs taken in the interval reaches a predetermined value, and the next interval may be started.

(4) Control over Switch 164 According to Heating Profile

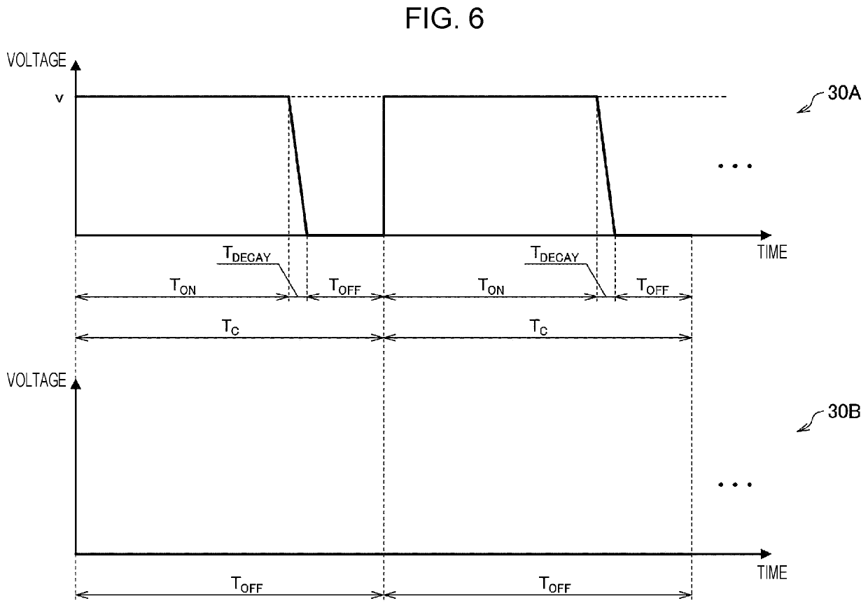

The inhaler device 100 controls each of the plurality of switches 164 in accordance with a heating profile. Control over the switch 164A and the switch 164B according to the heating profile shown in Table 1 will be described with reference to FIGS. 6 to 8.

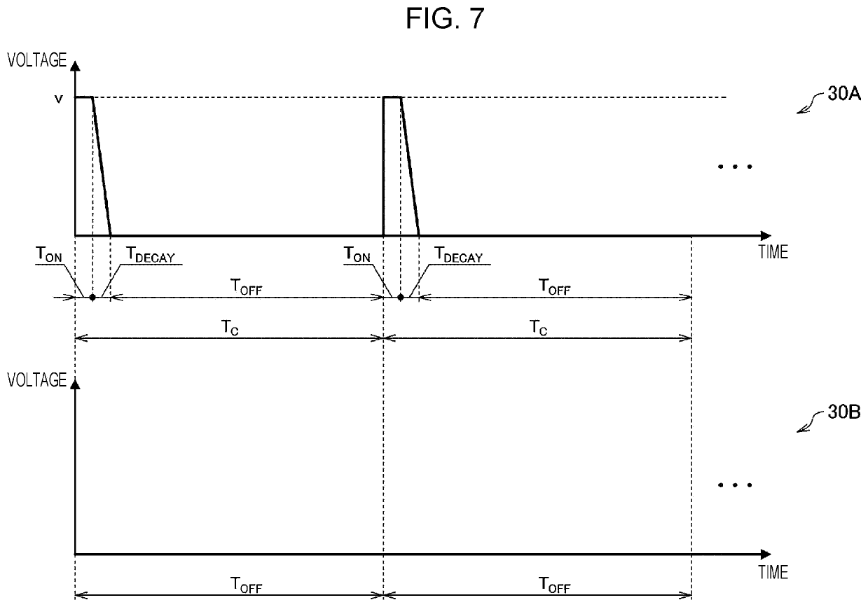

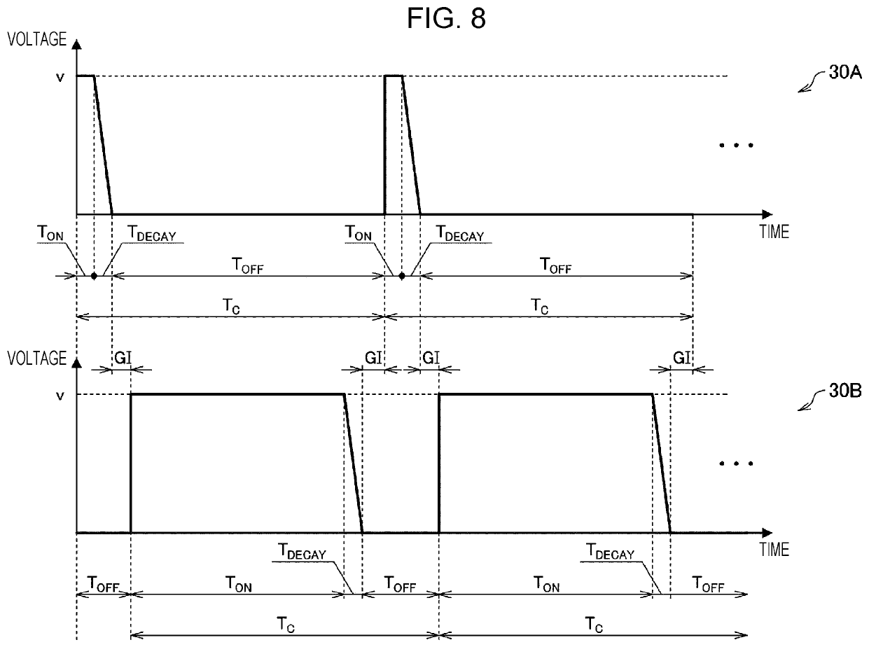

FIG. 6 is a timing chart for illustrating an example of the operations of the switch 164A and the switch 164B in the first temperature increasing interval. FIG. 7 is a timing chart for illustrating an example of the operations of the switch 164A and the switch 164B in the in-process temperature decreasing interval. FIG. 8 is a timing chart for illustrating an example of the operations of the switch 164A and the switch 164B in the second temperature increasing interval. In these charts, the graph 30A represents time-series changes of a voltage applied to the electromagnetic induction source 162A corresponding to the switch 164A. The graph 30B represents time-series changes of a voltage applied to the electromagnetic induction source 162B corresponding to the switch 164B. The abscissa axes of these graphs represent time. The ordinate axes of these graphs represent an effective value of voltage of alternating-current power applied to the electromagnetic induction source 162.

As shown in FIG. 6, in the first temperature increasing interval, the switch 164A operates in the high heating mode. Thus, the temperature of the susceptor 161A is increased up to a temperature tmp₁ and maintained. On the other hand, in the first temperature increasing interval, the switch 164B operates in the non-heating mode. Thus, the temperature of the susceptor 161B is maintained at an initial temperature.

As shown in FIG. 7, in the in-process temperature decreasing interval, the switch 164A operates in the low heating mode. Thus, the temperature of the susceptor 161A is decreased up to a temperature tmp₂. On the other hand, in the in-process temperature decreasing interval, the switch 164B operates in the non-heating mode. Thus, the temperature of the susceptor 161B is maintained at the initial temperature.

As shown in FIG. 8, in the second temperature increasing interval, the switch 164A operates in the low heating mode. Thus, the temperature of the susceptor 161A is maintained at the temperature tmp₂. On the other hand, in the second temperature increasing interval, the switch 164B operates in the high heating mode. Thus, the temperature of the susceptor 161B is increased up to the temperature tmp₁ and maintained.

Here, the controller 116 controls each of the plurality of switches 164 such that a total value of voltages respectively applied to the plurality of electromagnetic induction sources 162 is lower than or equal to a first threshold. The first threshold is set as a value such that, when a total value of voltages respectively applied to the plurality of electromagnetic induction sources 162 exceeds the first threshold, an excessive load may be exerted on structural elements such as the power supply 111, the inverter circuit 163, and the controller 116. With the above configuration, it is possible to prevent an excessive load from being exerted on the inhaler device 100. Thus, failure of the inhaler device 100 is prevented, and the quality of puff experience of a user is improved.

Hereinafter, a specific process for setting a total value of voltages respectively applied to the plurality of electromagnetic induction sources 162 to lower than or equal to the first threshold will be described.

As shown in FIGS. 6 to 8, in a period during which any one of the plurality of switches 164 is in the on state, the controller 116 sets all the remainder of the switches 164 to the off state. More specifically, in a period during which the switch 164A is in the on state, the controller 116 sets the switch 164B to the off state. On the other hand, in a period during which the switch 164B is in the on state, the controller 116 sets the switch 164A to the off state. With the above configuration, it is possible to prevent an excessive load from being exerted on the inhaler device 100.

Furthermore, as shown in FIGS. 6 to 8, in a period during which any one of the plurality of switches 164 is in the on state or in the attenuation state, the controller 116 sets all the remainder of the switches 164 to the off state. More specifically, in a period during which the switch 164A is in the on state or in the attenuation state, the controller 116 sets the switch 164B to the off state. On the other hand, in a period during which the switch 164B is in the on state or in the attenuation state, the controller 116 sets the switch 164A to the off state. With the above configuration, it is possible to further reliably prevent an excessive load from being exerted on the inhaler device 100 in consideration of a voltage in the attenuation state.

As shown in FIG. 8, the controller 116 may provide a guard period GI that is a period during which all of the plurality of switches 164 are set to the off state. A guard period GI functions as a fail-safe if an error or a delay occurs in control over any one of the plurality of switches 164. In other words, even when there occurs an error or a delay in control over any one of the plurality of switches 164, it is possible to set all of the plurality of switches 164 to the off state in the guard period GI. With the above configuration, it is possible to reliably prevent an excessive load from being exerted on the inhaler device 100.

As shown in FIGS. 6 to 8, of the plurality of electromagnetic induction sources 162, the controller 116 switches the switch 164 that operates in the high heating mode with a lapse of time. With the above configuration, it is possible to switch a part to be heated in the stick substrate 150 with a lapse of time. Therefore, the whole of the stick substrate 150 does not become a high temperature at once, so it is possible to extend the life of the stick substrate 150. Here, the life of the stick substrate 150 is a length of time until an aerosol source contained in the stick substrate 150 is depleted. The type or amount of an aerosol source and a flavor source contained may be varied between a part proximate to the susceptor 161A and a part proximate to the susceptor 161B in the substrate 151. In this case, a user is able to taste different flavors with a lapse of time.

Specifically, the controller 116 switches the switch 164 that operates in the high heating mode in order from the switch 164A corresponding to the electromagnetic induction source 162A disposed closest to the opening 142 to the switch 164B corresponding to the electromagnetic induction source 162B disposed farthest from the opening 142. In other words, the controller 116 initially causes the switch 164A to operate in the high heating mode and subsequently causes the switch 164B to operate in the high heating mode. Therefore, as shown in FIG. 5, the susceptor 161A becomes a high temperature first and then the susceptor 161B becomes a high temperature. With this configuration, an aerosol source is heated in order from a downstream-side part to an upstream-side part of the substrate 151, and an aerosol is generated. If the upstream-side part of the substrate 151 is heated in advance of the downstream-side part, an aerosol generated on the upstream side may be cooled to condense at the time of passing through the downstream-side part. In this case, the downstream-side part of the substrate 151 not yet heated gets wet, with the result that a flavor tasted by the user when the downstream-side part of the substrate 151 is heated can degrade. In terms of this point, with the above configuration, a generated aerosol does not pass through an unheated part in the substrate 151. Thus, an unheated part of the substrate 151 is prevented from getting wet, so it is possible to prevent degradation of a flavor tasted by the user.

As shown in FIGS. 6 and 7, the controller 116 causes the switch 164B to operate in the non-heating mode before the switch that operates in the high heating mode is switched from a first switch (that is, the switch 164A) to a second switch (that is, the switch 164B). With the above configuration, it is possible to maintain the upstream-side aerosol source in an unheated state. Thus, it is possible to extend the lift of the stick substrate 150.

As shown in FIGS. 7 and 8, the controller 116 causes the switch 164A to operate in the low heating mode after the switch 164A operates in the high heating mode. If the switch 164A is caused to operate in the non-heating mode, induction heating is not performed by the electromagnetic induction source 162A, so the downstream-side part of the substrate 151 is excessively cooled. In this case, an aerosol generated on the upstream side by induction heating performed by the electromagnetic induction source 162B may be cooled to condense at the time of passing through the downstream-side part of the substrate 151. In this case, the downstream-side part of the substrate 151 gets wet, and a flavor tasted by the user can degrade. In terms of this point, with the above configuration, it is possible to prevent condensation of an aerosol flowing from the upstream side to the downstream side of the substrate 151 by continuing feeding of electric power to the electromagnetic induction source 162A with a very small amount. Thus, it is possible to prevent degradation of a flavor tasted by the user.

The temperature tmp₂ of the susceptor 161A inductively heated by the electromagnetic induction source 162A corresponding to the switch 164A that operates in the high heating mode and then operates in the low heating mode is desirably a temperature higher than or equal to a temperature at or above which an aerosol does not condense. With the above configuration, it is possible to heat (that is, keep the temperature of) the downstream side to such an extent that an aerosol flowing from the upstream side to the downstream side of the substrate 151 does not condense, by continuing feeding of electric power to the electromagnetic induction source 162A with a very small amount. Thus, it is possible to further reliably prevent degradation of a flavor tasted by the user.

When the controller 116 switches the switch 164 that operates in the high heating mode from the switch 164A to the switch 164B, the controller 116 causes the switch 164A to start operation in the low heating mode and, after a lapse of a predetermined time, causes the switch 164B to start operation in the high heating mode. The predetermined time corresponds to a length of time from time t₂ to time t₃, which is a length of the in-process temperature decreasing interval. With a period during which the switch 164A operates in the low heating mode alone, it is possible to reliably separate the interval in which the switch 164A operates in the high heating mode (that is, the first temperature increasing interval) and the interval in which the switch 164B operates in the high heating mode (that is, the second temperature increasing interval) from each other. Thus, even when there occurs an error or a delay in control over any one of the plurality of switches 164, it is possible to prevent a situation in which both the switch 164A and the switch 164B operate in the high heating mode. Therefore, it is possible to reliably prevent an excessive load from being exerted on the inhaler device 100.

As shown in FIG. 5, in the predetermined time, the temperature of the susceptor 161A inductively heated by the electromagnetic induction source 162A corresponding to the switch 164A decreases. Thus, after the temperature of the susceptor 161A sufficiently decreases, the second temperature increasing interval is started, and the temperature of the susceptor 161B reaches a high temperature. Thus, it is possible to prevent generation of an excessively large amount of aerosol as a result of a situation in which both the susceptor 161A and the susceptor 161B become a high temperature. As a result, it is possible to maintain the quality of a flavor tasted by a user at a constant level.

Here, the predetermined time is set such that, while an aerosol is being generated by induction heating performed by the electromagnetic induction source 162A corresponding to the switch 164A, an aerosol is generated by induction heating performed by the electromagnetic induction source 162B corresponding to the switch 164B. In other words, the second temperature increasing interval starts at timing at which the downstream-side aerosol source has not reached the life. It is presumable that there is a time lag from when the switch 164B starts operation in the high heating mode to when the susceptor 161B is sufficiently warmed and an aerosol is generated. In terms of this point, with the above configuration, in the time lag, it is possible to generate an aerosol from the downstream-side aerosol source. Thus, the user is able to inhale a suitable aerosol even when the user takes a puff in the time lag.

(5) Flow of Process

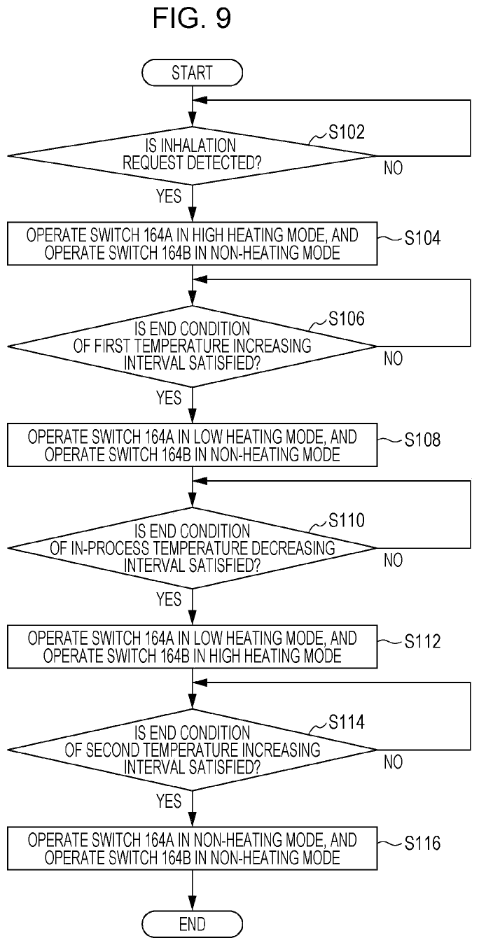

FIG. 9 is a flowchart that illustrates an example of the flow of a process that is executed by the inhaler device 100 according to the present embodiment.

As shown in FIG. 9, initially, the controller 116 determines whether an inhalation request is detected (step S102). An inhalation request is a user operation to request to generate an aerosol. An example of the inhalation request is an operation to the inhaler device 100, such as operating a switch or the like provided in the inhaler device 100. Another example of the inhalation request is to insert the stick substrate 150 into the inhaler device 100.

Insertion of the stick substrate 150 into the inhaler device 100 may be detected by a capacitance proximity sensor provided around the opening 142. The capacitance proximity sensor is a sensor that generates an electric field and that detects an object in accordance with a change in capacitance or dielectric constant at the time when the object enters into an electric field. The proximity sensor provided around the opening 142 detects the capacitance, dielectric constant, or the like of a partial space around the opening 142 in the internal space 141. As the stick substrate 150 is inserted or removed, various parts (a part including the susceptor 161 and a part not including the susceptor 161) of the stick substrate 150 pass through the partial space. Accordingly, the capacitance and dielectric constant of the partial space change. Therefore, the controller 116 is capable of determining whether the stick substrate 150 is held by the holder 140 in accordance with time-series changes in the capacitance or dielectric constant of the partial space.

When it is determined that an inhalation request is not detected (NO in step S102), the controller 116 waits until an inhalation request is detected.

When it is determined that an inhalation request is detected (YES in step S102), the controller 116 causes the switch 164A to operate in the high heating mode and causes the switch 164B to operate in the non-heating mode (step S104). Thus, the first temperature increasing interval is started.

Subsequently, the controller 116 determines whether an end condition of the first temperature increasing interval is satisfied (step S106). An example of the end condition of the first temperature increasing interval is that an elapsed time from the start of heating has reached a time t₂. Another example of the end condition of the first temperature increasing interval is that the number of puffs in the first temperature increasing interval has reached a predetermined number of times.

When it is determined that the end condition of the first temperature increasing interval is not satisfied (NO in step S106), the controller 116 waits until the end condition of the first temperature increasing interval is satisfied.

When it is determined that the end condition of the first temperature increasing interval is satisfied (YES in step S106), the controller 116 causes the switch 164A to operate in the low heating mode and causes the switch 164B to operate in the non-heating mode (step S108). Thus, the in-process temperature decreasing interval is started.

Subsequently, the controller 116 determines whether an end condition of the in-process temperature decreasing interval is satisfied (step S110). An example of the end condition of the in-process temperature decreasing interval is that an elapsed time from the start of heating has reached a time t₃. Another example of the end condition of the in-process temperature decreasing interval is that the number of puffs in the in-process temperature decreasing interval has reached a predetermined number of times.

When it is determined that the end condition of the in-process temperature decreasing interval is not satisfied (NO in step S110), the controller 116 waits until the end condition of the in-process temperature decreasing interval is satisfied.

When it is determined that the end condition of the in-process temperature decreasing interval is satisfied (YES in step S110), the controller 116 causes the switch 164A to operate in the low heating mode and causes the switch 164B to operate in the high heating mode (step S112) Thus, the second temperature increasing interval is started.

Subsequently, the controller 116 determines whether an end condition of the second temperature increasing interval is satisfied (step S114). An example of the end condition of the second temperature increasing interval is that an elapsed time from the start of heating has reached a time t₅. Another example of the end condition of the second temperature increasing interval is that the number of puffs in the second temperature increasing interval has reached a predetermined number of times.

When it is determined that the end condition of the second temperature increasing interval is not satisfied (NO in step S114), the controller 116 waits until the end condition of the second temperature increasing interval is satisfied.

When it is determined that the end condition of the second temperature increasing interval is satisfied (YES in step S114), the controller 116 causes the switch 164A to operate in the non-heating mode and causes the switch 164B to operate in the non-heating mode (step S116). Thus, the heating end interval is started.

<4. Modifications>

<4.1. First Modification>

In the above-described embodiment, an example in which the guard period GI is provided at the time of switching the switch 164 to be set to the on state has been described; however, the present invention is not limited to the example. The guard period GI does not need to be provided at the time of switching the switch 164 to be set to the on state. However, in a period during which any one of the plurality of switches 164 is in the attenuation state, at timing at which the voltage of alternating-current power supplied to the electromagnetic induction source 162 corresponding to the switch 164 in the attenuation state becomes lower than or equal to the second threshold, the controller 116 sets another one of the switches 164 to the on state. A second threshold is set such that the sum of the second threshold and a prescribed voltage applied to the electromagnetic induction source 162 corresponding to the switch 164 that operates in the on state is lower than or equal to a first threshold. With the above configuration, after the voltage supplied from the switch 164 having operated in the on state till then to the electromagnetic induction source 162 attenuates to a certain degree, another switch 164 starts operation in the on state. Therefore, a total value of voltages respectively applied to the plurality of electromagnetic induction sources 162 can be lower than or equal to the first threshold. Since no guard period in which any of the susceptors 161 is not inductively heated is provided, it is possible to enhance heating efficiency.

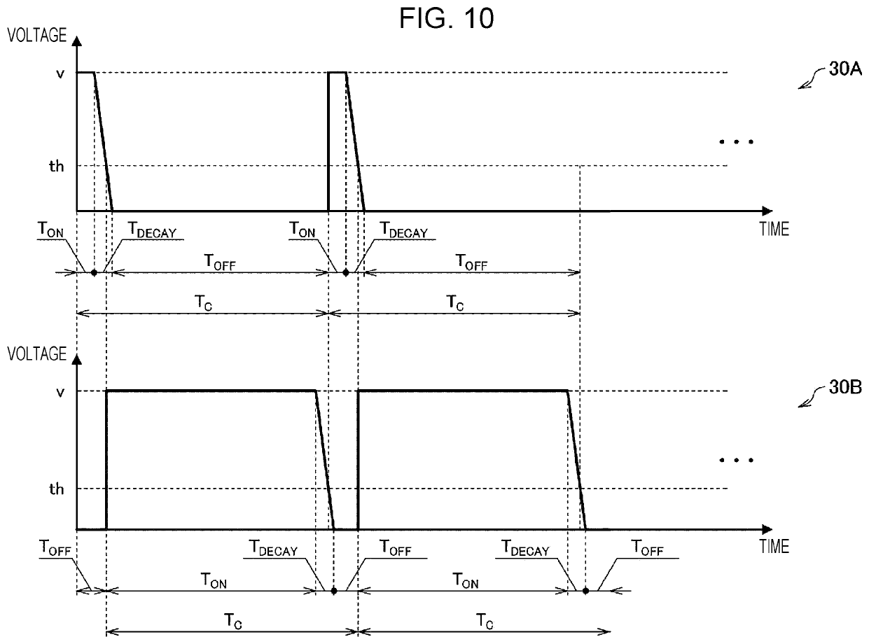

An example of control details according to the present modification will be described with reference to FIG. 10.

FIG. 10 is a timing chart for illustrating another example of the operations of the switch 164A and the switch 164B in the second temperature increasing interval. In the present modification, control shown in FIG. 10 instead of control shown in FIG. 8 is executed in the second temperature increasing interval as control over the switch 164A and the switch 164B in accordance with the heating profile shown in Table 1. The graph 30A represents time-series changes of a voltage applied to the electromagnetic induction source 162A corresponding to the switch 164A. The graph 30B represents time-series changes of a voltage applied to the electromagnetic induction source 162B corresponding to the switch 164B. The abscissa axes of these graphs represent time. The ordinate axes of these graphs represent an effective value of voltage of alternating-current power applied to the electromagnetic induction source 162.

As shown in FIG. 10, in the second temperature increasing interval, the switch 164A operates in the low heating mode. Thus, the temperature of the susceptor 161A is maintained at the temperature tmp₂. On the other hand, in the second temperature increasing interval, the switch 164B operates in the high heating mode. Thus, the temperature of the susceptor 161B is increased up to the temperature tmp₁ and maintained.

However, as shown in FIG. 10, the switch 164A switches into the on state at timing at which the voltage supplied to the electromagnetic induction source 162B corresponding to the switch 164B becomes lower than or equal to a second threshold th. Similarly, the switch 164B switches into the on state at timing at which the voltage supplied to the electromagnetic induction source 162A corresponding to the switch 164A becomes lower than or equal to the second threshold th. The second threshold th is set such that the sum of a voltage v and the second threshold th is lower than or equal to the first threshold. In other words, at the timing of switching, a total value of voltages respectively applied to the electromagnetic induction source 162A and the electromagnetic induction source 162B becomes lower than or equal to the first threshold.

<4.2. Second Modification>

In the above-described embodiment, an example in which, before the switch 164 that operates in the high heating mode is switched from the switch 164A to the switch 164B, the switch 164B is operated in the non-heating mode has been described; however, the present invention is not limited to this example. Before the controller 116 switches the switch 164 that operates in the high heating mode from the switch 164A to the switch 164B, the controller 116 may cause the switch 164B to operate in the low heating mode. With the above configuration, before the switch 164B starts operation in the high heating mode, it is possible to place the susceptor 161B in a state of being heated to a certain degree although the susceptor 161B has a low temperature. Thus, after the switch 164B starts operation in the high heating mode, it is possible to advance time until the susceptor 161B reaches a temperature at which an aerosol can be generated.

An example of the heating profile according to the present modification is shown in the following Table 2.

TABLE 2
Table 2 Example of Heating Profile

| | Elapsed Time from | Target Temperature | Target Temperature |
|---|---|---|---|
| Time Interval | Start of Heating | of Susceptor 161A | of Susceptor 161B |
| First Temperature | t₁ (s) | tmp₁° C. | tmp₂° C. |
| Increasing Interval | t₂ (s) | tmp₁° C. | tmp₂° C. |
| In-Process Temperature | t₃ (s) | tmp₂° C. | tmp₂° C. |
| Decreasing Interval | | | |
| Second Temperature | t₇ (s) | tmp₂° C. | tmp₁° C. |
| Increasing Interval | t₅ (s) | tmp₂° C. | tmp₁° C. |
| Heating End Interval | Thereafter | — | — |

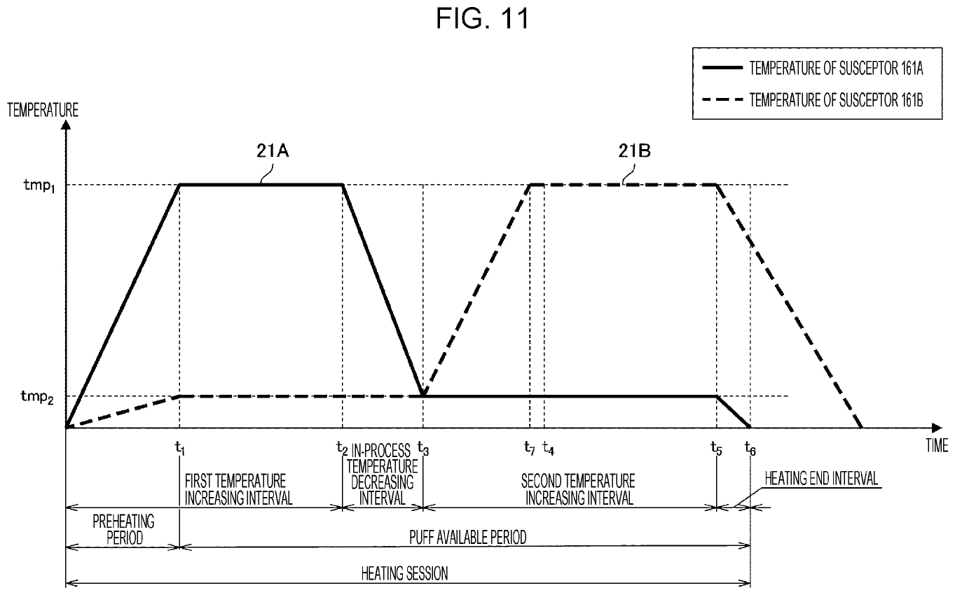

FIG. 11 is a graph that shows an example of time-series changes of a real temperature of the susceptor 161 inductively heated in accordance with the heating profile shown in Table 2. The abscissa axis of the graph represents time (s). The ordinate axis of the graph represents the temperature of the susceptor 161. The line 21A represents time-series changes of the real temperature of the susceptor 161A. The line 21B represents time-series changes of the real temperature of the susceptor 161B. As shown in FIG. 11, the real temperature of each of the susceptors 161A, 161B changes as in the case of time-series changes of the target temperature defined in the heating profile.

As shown in Table 2 and FIG. 11, the temperature of the susceptor 161B increases up to the temperature tmp₂° C. in the first temperature increasing interval and maintains the temperature tmp₂° C. until the second temperature increasing interval starts. In the second temperature increasing interval, the temperature of the susceptor 161B reaches the temperature tmp₁ after t₇ seconds from the start of heating. t₁ is smaller than t₄. In this way, in the second temperature increasing interval, time at which the temperature of the susceptor 161B reaches the temperature tmp₁ can be advanced as compared to the example shown in Table 1 and FIG. 5. The other points are similar to those of the example shown in Table 1 and FIG. 5.

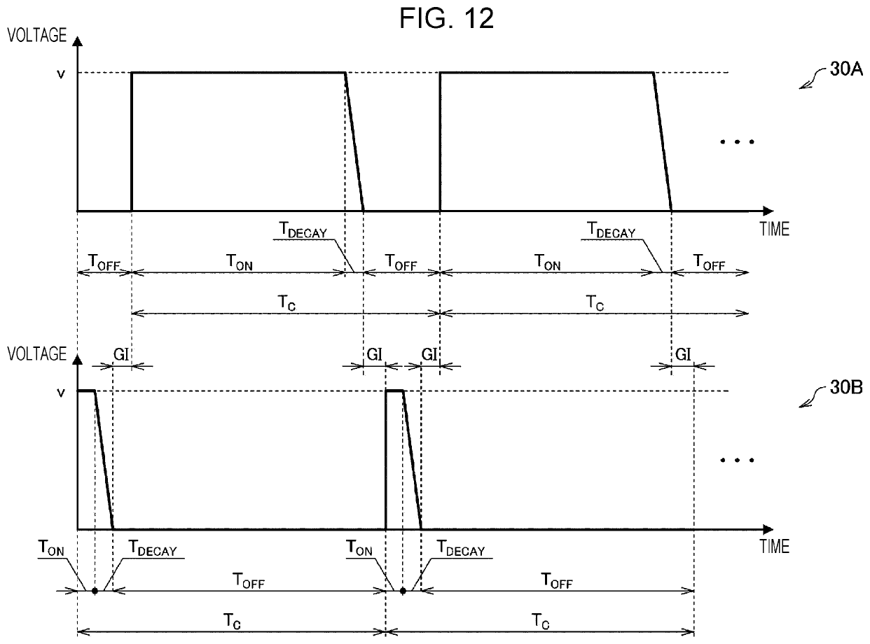

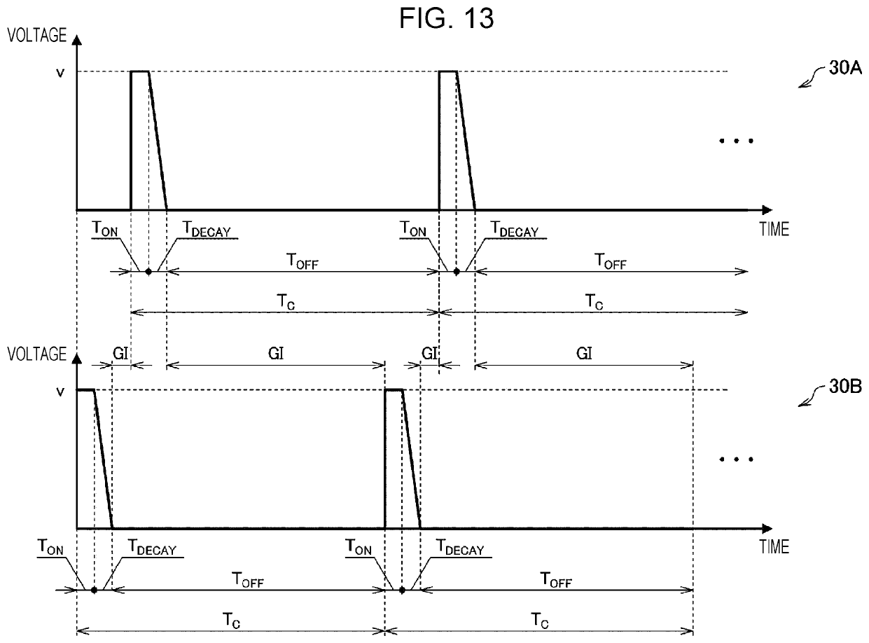

An example of control details according to the present modification will be described with reference to FIGS. 12 and 13 and further with reference to FIG. 8 again. In the present modification, the switch 164A and the switch 164B operate as shown in FIG. 12 in the first temperature increasing interval, operate as shown in FIG. 13 in the in-process temperature decreasing interval, and operate as shown in FIG. 8 in the second temperature increasing interval.

FIG. 12 is a timing chart for illustrating an example of the operations of the switch 164A and the switch 164B in the first temperature increasing interval. FIG. 13 is a timing chart for illustrating an example of the operations of the switch 164A and the switch 164B in the in-process temperature decreasing interval. In these charts, the graph 30A represents time-series changes of a voltage applied to the electromagnetic induction source 162A corresponding to the switch 164A. The graph 30B represents time-series changes of a voltage applied to the electromagnetic induction source 162B corresponding to the switch 164B. The abscissa axes of these graphs represent time. The ordinate axes of these graphs represent an effective value of voltage of alternating-current power applied to the electromagnetic induction source 162.

As shown in FIG. 12, in the first temperature increasing interval, the switch 164A operates in the high heating mode. Thus, the temperature of the susceptor 161A is increased up to the temperature tmp₁ and maintained. On the other hand, in the first temperature increasing interval, the switch 164B operates in the low heating mode. Thus, the temperature of the susceptor 161B is increased up to the temperature tmp₂ and maintained.

As shown in FIG. 13, in the in-process temperature decreasing interval, the switch 164A operates in the low heating mode. Thus, the temperature of the susceptor 161A is decreased up to the temperature tmp₂. On the other hand, in the in-process temperature decreasing interval, the switch 164B operates in the low heating mode. Thus, the temperature of the susceptor 161B is maintained at the temperature tmp₂.

<5. Supplement>

The preferred embodiment of the present invention has been described in detail with reference to the attached drawings; however, the present invention is not limited to those examples. It is obvious that persons having ordinary skill in the art in the field of technology to which the present invention belongs can conceive of various modifications or alterations within the scope of the technical idea recited in the claims, and these can also be naturally interpreted as belonging to the technical scope of the present invention.

For example, in the above embodiment, an example in which the switch 164 is disposed between the inverter circuit 163 and the electromagnetic induction source 162 has been described; however, the present invention is not limited to this example. The inhaler device 100 may include an inverter circuit 163A that supplies alternating-current power to the electromagnetic induction source 162A and an inverter circuit 163B that supplies alternating-current power to the electromagnetic induction source 162B. In this case, the switch 164A is disposed between the power supply 111 and the inverter circuit 163A. On the other hand, the switch 164B is disposed between the power supply 111 and the inverter circuit 163B.

For example, in the above embodiment, an example in which the inhaler device 100 includes two electromagnetic induction sources 162 has been described; however, the present invention is not limited to this example. The inhaler device 100 may include three or more electromagnetic induction sources 162.

For example, in the above embodiment, an example in which the number of susceptors 161 included in the stick substrate 150 coincides with the number of electromagnetic induction sources 162 of the inhaler device 100 has been described; however, the present invention is not limited to this example. The number of susceptors 161 included in the stick substrate 150 may be different from the number of electromagnetic induction sources 162 of the inhaler device 100.

For example, in the above embodiment, an example in which the susceptor 161 has a sheet shape has been described; however, the present invention is not limited to this example. For example, the susceptor 161 may be formed in a rod shape or may be formed as pieces of metal and widely distributed in the substrate 151.

For example, in the above embodiment, an example in which the susceptor 161 is included in the stick substrate 150 has been described; however, the present invention is not limited to this example. In other words, the susceptor 161 can be disposed at any location at which the susceptor 161 is in thermal proximity to the aerosol source. In an example, the susceptor 161 may be formed in a blade shape and disposed so as to protrude from the bottom 143 of the holder 140 into the internal space 141. When the stick substrate 150 is inserted into the holder 140, the stick substrate 150 is inserted such that the blade-shaped susceptor 161 sticks into the substrate 151 from an end of the stick substrate 150 in an insertion direction.

A series of pieces of processing, executed by the devices, described in the specification, may be implemented by any one of software, hardware, and a combination of software and hardware. Programs that are components of software are prestored in, for example, storage media (non-transitory media) provided inside or outside the devices. The programs are, for example, loaded onto a RAM when a computer that controls the devices described in the specification runs the programs and are run on a processor, such as a CPU. Examples of the storage media include a magnetic disk, an optical disk, a magneto-optical disk, and a flash memory. The computer programs may be distributed via, for example, a network, without using storage media.

Pieces of processing described by using the flowchart and the sequence diagram in the specification may be not necessarily executed in order as illustrated. Some processing steps may be executed in parallel. An additional processing step may be adopted, and one or some of the processing steps may be omitted.

The following configurations also belong to the technical scope of the present invention.

(1)
An inhaler device includes:
an alternating-current power generator that generates alternating-current power;
a container capable of accommodating a substrate containing an aerosol source and a susceptor in thermal proximity to the aerosol source in an internal space;
a plurality of electromagnetic induction sources that generate a varying magnetic field in the internal space by using the alternating-current power supplied from the alternating-current power generator;
a plurality of switches that each switch whether to supply alternating-current power to a corresponding one of the plurality of electromagnetic induction sources; and
a controller that controls each of the plurality of switches such that a total value of voltages respectively applied to the plurality of electromagnetic induction sources is lower than or equal to a first threshold.

(2)
In the inhaler device according to the above (1),
each of the switches operates in a state of any one of a plurality of operating states,
the plurality of operating states includes an on state where the alternating-current power is supplied to the electromagnetic induction source at a prescribed voltage and an off state where the alternating-current power is not supplied to the electromagnetic induction source, and
in a period during which any one of the plurality of switches is in the on state, the controller sets all the remainder of the switches to the off state.

(3)
In the inhaler device according to the above (2),
the controller provides a period during which all of the plurality of switches are set to the off state.

(4)
In the inhaler device according to the above (2) or (3),
the plurality of operating states includes an attenuation state where the voltage of the alternating-current power supplied to the electromagnetic induction source gradually attenuates, and
in a period during which any one of the plurality of switches is in the on state or in the attenuation state, the controller sets all the remainder of the switches to the off state.

(5)
In the inhaler device according to the above (2) or (3),
the plurality of operating states includes an attenuation state where the voltage of the alternating-current power supplied to the electromagnetic induction source gradually attenuates, and
in a period during which any one of the plurality of switches is in the attenuation state, the controller sets another one of the switches to the on state at timing at which the voltage of the alternating-current power supplied to the electromagnetic induction source corresponding to the switch in the attenuation state becomes lower than or equal to a second threshold.

(6)
In the inhaler device according to the above (4) or (5),
each of the switches is a field effect transistor (FET),
the on state is a state where the voltage is applied to a gate electrode of the switch,
the off state is a state where no voltage is applied to the gate electrode of the switch and no current is flowing between a source electrode and a drain electrode, and
the attenuation state is a state where no voltage is applied to the gate electrode of the switch and a current is flowing between the source electrode and the drain electrode.

(7)
In the inhaler device according to any one of the above (2) to (6),
the container has an opening that communicates the internal space with an outside and accommodates the substrate inserted into the internal space through the opening, and
the plurality of electromagnetic induction sources is disposed at different locations in a direction in which the substrate is inserted.

(8)
In the inhaler device according to the above (7),
the controller controls each of the plurality of switches such that the switch operates in any one of a high heating mode in which a proportion of time during which the switch operates in the on state is high in a unit time, a low heating mode in which a proportion of time during which the switch operates in the on state is low in the unit time, and a non-heating mode in which the entire unit time is occupied by time during which the switch operates in the off state.

(9)
In the inhaler device according to the above (8),
of the plurality of electromagnetic induction sources, the controller switches the switch that operates in the high heating mode with a lapse of time.

(10)
In the inhaler device according to the above (9),
the controller switches the switch that operates in the high heating mode in order from the switch corresponding to the electromagnetic induction source disposed closest to the opening to the switch corresponding to the electromagnetic induction source disposed farthest from the opening.

(11)
In the inhaler device according to the above (10),
the controller causes the switch to operate in the low heating mode after the switch operates in the high heating mode.

(12)
In the inhaler device according to the above (11),
a temperature of the susceptor inductively heated by the electromagnetic induction source corresponding to the switch that operates in the low heating mode after the switch operates in the high heating mode is a temperature higher than or equal to a temperature at which the aerosol does not condense.

(13)
In the inhaler device according to the above (11) or (12),
when the controller switches the switch that operates in the high heating mode from a first switch to a second switch, the controller causes the first switch to start operation in the low heating mode and, after a lapse of a predetermined time, causes the second switch to start operation in the high heating mode.

(14)
In the inhaler device according to the above (13),
in the predetermined time, a temperature of the susceptor inductively heated by a first electromagnetic induction source corresponding to the first switch decreases.

(15)
In the inhaler device according to the above (13) or (14),
the predetermined time is set such that, while an aerosol is being generated by induction heating performed by a first electromagnetic induction source corresponding to the first switch, an aerosol is generated by induction heating performed by a second electromagnetic induction source corresponding to the second switch.

(16)
In the inhaler device according to any one of the above (10) to (15),
before the controller switches the switch that operates in the high heating mode from a first switch to a second switch, the controller causes the second switch to operate in the non-heating mode.

(17)
In the inhaler device according to any one of the above (10) to (15),
before the controller switches the switch that operates in the high heating mode from a first switch to a second switch, the controller causes the second switch to operate in the low heating mode.

(18)
A substrate is used with an inhaler device, the inhaler device including
an alternating-current power generator that generates alternating-current power,
a container capable of accommodating a substrate containing an aerosol source and a susceptor in thermal proximity to the aerosol source in an internal space,
a plurality of electromagnetic induction sources that generate a varying magnetic field in the internal space by using the alternating-current power supplied from the alternating-current power generator,
a plurality of switches that each switch whether to supply alternating-current power to a corresponding one of the plurality of electromagnetic induction sources, and
a controller that controls each of the plurality of switches such that a total value of voltages respectively applied to the plurality of electromagnetic induction sources is lower than or equal to a first threshold,
the substrate is accommodated in the container, and includes:
the aerosol source; and
the susceptor in thermal proximity to the aerosol source.

(19)
A control method for controlling an inhaler device,
the inhaler device including
an alternating-current power generator that generates alternating-current power,
a container capable of accommodating a substrate containing an aerosol source and a susceptor in thermal proximity to the aerosol source in an internal space,
a plurality of electromagnetic induction sources that generate a varying magnetic field in the internal space by using the alternating-current power supplied from the alternating-current power generator, and
a plurality of switches that each switch whether to supply alternating-current power to a corresponding one of the plurality of electromagnetic induction sources,
the control method includes
controlling each of the plurality of switches such that a total value of voltages respectively applied to the plurality of electromagnetic induction sources is lower than or equal to a first threshold.

(20)
A program to be executed by a computer that controls an inhaler device,
the inhaler device including
an alternating-current power generator that generates alternating-current power,
a container capable of accommodating a substrate containing an aerosol source and a susceptor in thermal proximity to the aerosol source in an internal space,
a plurality of electromagnetic induction sources that generate a varying magnetic field in the internal space by using the alternating-current power supplied from the alternating-current power generator, and
a plurality of switches that each switch whether to supply alternating-current power to a corresponding one of the plurality of electromagnetic induction sources,
the program executing
controlling each of the plurality of switches such that a total value of voltages respectively applied to the plurality of electromagnetic induction sources is lower than or equal to a first threshold.

### REFERENCE SIGNS LIST

100 inhaler device
111 power supply
112 sensor
113 notifier
114 memory
115 communicator
116 controller
140 holder (container)
141 internal space
142 opening
143 bottom
150 stick substrate
151 substrate
152 inhalation port
161 susceptor
162 electromagnetic induction source
163 inverter circuit
164 switch
169 drive circuit

1. An inhaler device comprising:
an alternating-current power generator that generates alternating-current power;
a container capable of accommodating a substrate containing an aerosol source and a susceptor in thermal proximity to the aerosol source in an internal space;
a plurality of electromagnetic induction sources that generate a varying magnetic field in the internal space by using the alternating-current power supplied from the alternating-current power generator;
a plurality of switches that each switch whether to supply alternating-current power to a corresponding one of the plurality of electromagnetic induction sources; and
a controller that controls each of the plurality of switches such that a total value of voltages respectively applied to the plurality of electromagnetic induction sources is lower than or equal to a first threshold.

2. The inhaler device according to claim 1, wherein
each of the switches operates in a state of any one of a plurality of operating states,
the plurality of operating states includes an on state where the alternating-current power is supplied to the electromagnetic induction source at a prescribed voltage and an off state where the alternating-current power is not supplied to the electromagnetic induction source, and
in a period during which any one of the plurality of switches is in the on state, the controller sets all the remainder of the switches to the off state.

3. The inhaler device according to claim 2, wherein
the controller provides a period during which all of the plurality of switches are set to the off state.

4. The inhaler device according to claim 2, wherein
the plurality of operating states includes an attenuation state where the voltage of the alternating-current power supplied to the electromagnetic induction source gradually attenuates, and
in a period during which any one of the plurality of switches is in the on state or in the attenuation state, the controller sets all the remainder of the switches to the off state.

5. The inhaler device according to claim 2, wherein
the plurality of operating states includes an attenuation state where the voltage of the alternating-current power supplied to the electromagnetic induction source gradually attenuates, and
in a period during which any one of the plurality of switches is in the attenuation state, the controller sets another one of the switches to the on state at timing at which the voltage of the alternating-current power supplied to the electromagnetic induction source corresponding to the switch in the attenuation state becomes lower than or equal to a second threshold.

6. The inhaler device according to claim 4, wherein
each of the switches is a field effect transistor (FET),
the on state is a state where the voltage is applied to a gate electrode of the switch,
the off state is a state where no voltage is applied to the gate electrode of the switch and no current is flowing between a source electrode and a drain electrode, and
the attenuation state is a state where no voltage is applied to the gate electrode of the switch and a current is flowing between the source electrode and the drain electrode.

7. The inhaler device according to claim 2, wherein
the container has an opening that communicates the internal space with an outside and accommodates the substrate inserted into the internal space through the opening, and
the plurality of electromagnetic induction sources is disposed at different locations in a direction in which the substrate is inserted.

8. The inhaler device according to claim 7, wherein
the controller controls each of the plurality of switches such that the switch operates in any one of a high heating mode in which a proportion of time during which the switch operates in the on state is high in a unit time, a low heating mode in which a proportion of time during which the switch operates in the on state is low in the unit time, and a non-heating mode in which the entire unit time is occupied by time during which the switch operates in the off state.

9. The inhaler device according to claim 8, wherein
of the plurality of electromagnetic induction sources, the controller switches the switch that operates in the high heating mode with a lapse of time.

10. The inhaler device according to claim 9, wherein
the controller switches the switch that operates in the high heating mode in order from the switch corresponding to the electromagnetic induction source disposed closest to the opening to the switch corresponding to the electromagnetic induction source disposed farthest from the opening.

11. The inhaler device according to claim 10, wherein
the controller causes the switch to operate in the low heating mode after the switch operates in the high heating mode.

12. The inhaler device according to claim 11, wherein
a temperature of the susceptor inductively heated by the electromagnetic induction source corresponding to the switch that operates in the low heating mode after the switch operates in the high heating mode is a temperature higher than or equal to a temperature at which the aerosol does not condense.

13. The inhaler device according to claim 11, wherein
when the controller switches the switch that operates in the high heating mode from a first switch to a second switch, the controller causes the first switch to start operation in the low heating mode and, after a lapse of a predetermined time, causes the second switch to start operation in the high heating mode.

14. The inhaler device according to claim 13, wherein
in the predetermined time, a temperature of the susceptor inductively heated by a first electromagnetic induction source corresponding to the first switch decreases.

15. The inhaler device according to claim 13, wherein
the predetermined time is set such that, while an aerosol is being generated by induction heating performed by a first electromagnetic induction source corresponding to the first switch, an aerosol is generated by induction heating performed by a second electromagnetic induction source corresponding to the second switch.

16. The inhaler device according to claim 10, wherein
before the controller switches the switch that operates in the high heating mode from a first switch to a second switch, the controller causes the second switch to operate in the non-heating mode.

17. The inhaler device according to claim 10, wherein
before the controller switches the switch that operates in the high heating mode from a first switch to a second switch, the controller causes the second switch to operate in the low heating mode.

18. A control method for controlling an inhaler device,
the inhaler device includes
an alternating-current power generator that generates alternating-current power,
a container capable of accommodating a substrate containing an aerosol source and a susceptor in thermal proximity to the aerosol source in an internal space,
a plurality of electromagnetic induction sources that generate a varying magnetic field in the internal space by using the alternating-current power supplied from the alternating-current power generator, and
a plurality of switches that each switch whether to supply alternating-current power to a corresponding one of the plurality of electromagnetic induction sources,
the control method comprising
controlling each of the plurality of switches such that a total value of voltages respectively applied to the plurality of electromagnetic induction sources is lower than or equal to a first threshold.

19. A non-transitory computer readable medium having a program stored therein, the program to be executed by a computer that controls an inhaler device,
the inhaler device including
an alternating-current power generator that generates alternating-current power,
a container capable of accommodating a substrate containing an aerosol source and a susceptor in thermal proximity to the aerosol source in an internal space,
a plurality of electromagnetic induction sources that generate a varying magnetic field in the internal space by using the alternating-current power supplied from the alternating-current power generator, and
a plurality of switches that each switch whether to supply alternating-current power to a corresponding one of the plurality of electromagnetic induction sources,
the program executing
controlling each of the plurality of switches such that a total value of voltages respectively applied to the plurality of electromagnetic induction sources is lower than or equal to a first threshold.
